(19) United States
(12) Patent Application Publication
(10) Pub. No.: US 2020/0110264 A1
(43) Pub. Date: Apr. 9, 2020

(54) THIRD-PERSON VR SYSTEM AND METHOD FOR USE THEREOF

(71) Applicant: NETEN INC., Kofu-shi (JP)

(72) Inventors: Kenji NANASAWA, Kofu-shi (JP); Tomoki NANASAWA, Kofu-shi (JP)

(73) Assignee: NETEN INC., Kofu-shi (JP)

(21) Appl. No.: 16/592,408

(22) Filed: Oct. 3, 2019

(30) Foreign Application Priority Data
Oct. 5, 2018 (JP) 2018-190456
May 8, 2019 (JP) 2019-088491

(51) Int. Cl. G02B 27/01; G06T 19/00; G06F 3/01; H04N 7/18; G06T 15/08

(52) U.S. Cl. CPC G02B 27/017; G06T 19/006; G06T 15/08; H04N 7/185; G06F 3/011

(57) ABSTRACT

A method for using a third-person VR system including: a non-transmissive head mount display, an imaging section, and a relay section, includes: attaching a non-transmissive head mount display to a head of a user such that the non-transmissive head mount display enables the user to see an image; capturing a moving image including at least the user wearing the head mount display by an imaging section; sending, by a relay section, the moving image captured by the imaging section to the head mount display; sending, by the relay section, the image captured by the imaging section by using a communication line such as Internet, to the head mount display in real time; and allowing the user to perform an activity while the user see an image of the user displayed on the head mount display.

### CROSS-REFERENCE TO RELATED APPLICATION

This application claims priority to Japanese Patent Application No. 2018-190456 filed on Oct. 5, 2018 and Japanese Patent Application No. 2019-088491 filed on May 8, 2019, the disclosures of which including the specifications, the drawings, and the claims are hereby incorporated by reference in his/her entirety.

### BACKGROUND

The present disclosure relates to a third-person VR system for enabling a user to see the user himself/herself from a third-person viewpoint using a virtual reality (VR) technology, and a method for use thereof.

In recent years, head mount displays (HMDs) for VR games have appeared on the market, and the VR technology has been applied to various fields.

Japanese Patent No. 6395098, for example, shows a known game system that displays a game image in which an object placed in a virtual space is seen from a virtual viewpoint.

On the other hand, Japanese Patent Application Publication No. 2017-189591, for example, describes a known medical VR preparation tool that reproduces pictures and sound for a patient under a treatment or the like in a medical field to enable an efficient treatment, for example, while providing various contents and simulations effective for preparation.

Japanese Patent No. 6094190 proposes known information processing apparatus including a display control unit configured to include a first display control mode and a second display control mode. In the first display control mode, control of displaying, on a display unit, a first image from a user viewpoint captured by a first imaging section is performed or control with which the display unit is transmissive is performed. In the second display control mode, control of displaying a second image captured by a second imaging section at the rear of a user and including at least one of the back of the head, the top of the head, or the back of the body of the user within an angle of view, is performed.

### SUMMARY

In the VR technology known to date, however, although it is possible to operate a character representing the user in a virtual space or to perform a simulation using contents prepared beforehand, the user does not generally see himself/herself from a third-person viewpoint.

There is also a limitation in perception in seeing the user himself/herself by his/her own eyes or through a mirror or a recorded picture.

On the other hand, in Japanese Patent No. 6094190, in a state using a transmissive head mount display, pictures seen by eyes of the user himself/herself are included in a considerable proportion in a state using a transmissive head mount display, and thus, it is actually difficult for the user to perceive an out-of-body viewpoint (third-person viewpoint).

It is therefore an object of the present disclosure to enable a user to experience third-person VR easily.

The term “virtual” as used in virtual reality is often rendered as imaginary, fictitious, or pseudo. On the other hand, according to The American Heritage Dictionary, the term “virtual” is defined as “existing in essence or effect though not in actual fact or form.” That is, the term “virtual” can be regarded as “appearance and shape are not the same as those of the original, but are real and original inherently or in terms of effect.” Actual reality exists subliminally even without any of a head mount display and a computer technology. This is because consciousness is inherently a mechanism that processes VR (almost real). The term “VR” is used interchangeably in meanings of “almost real” and “a technology providing VR”. In view of this, the former will be simply referred to as “VR,” and the latter will be referred to as a VR technology (e.g., AR technology or MR technology) hereinafter.

To achieve the object, the first aspect of the present disclosure is directed to a method for using a third-person VR system including a non-transmissive head mount display, an imaging section, and a relay section, and the method includes: attaching the non-transmissive head mount display to a head of a user such that the non-transmissive head mount display enables the user to see an image; capturing a moving image including at least the user wearing the head mount display by the imaging section; sending, by relay section, the moving image captured by the imaging section to the head mount display; sending, by the relay section, the image captured by the imaging section by using a communication line such as Internet, to the head mount display in real time; and allowing the user to perform an activity while the user see an image of the user displayed on the head mount display.

That is, humans are accustomed to moving himself/herself while feeling his/her own bodies based on visual information obtained with his/her own eyes. With the configuration, however, since the user is wearing the non-transmissive head mount display, the user moves his/her body by seeing his/her own body based on an image from an imaging section relayed through a communication line such as the Internet, not through his/her own eyes. When the user sees himself/herself from the viewpoint of the imaging section (third person), the obtained image is different from an image seen with his/her own eyes and an image seen through a mirror. In addition, by moving his/her own body based on a viewpoint of a third person, the user can enjoy a fresh sense of feeling in moving his/her own body, not in moving a character on a screen.

The term “communication line such as the Internet” here refers to the Internet, a wireless LAN (including a closed communication environment in which only activity participants are participated), and a wireless communication. In particular, relaying through the Internet enables live relaying by providing the head mount display itself with a communication function, as in a case where the head mount display incorporates a smartphone, for example. Even if a large number of head mount displays are used, the case of using Internet relaying is less likely to degrade a communication state than the case of using a wireless LAN. Furthermore, the user can enjoy a sense of feeling different from usual in performing an activity because of a slight time difference over the Internet relaying. On the other hand, an advantage in performing an activity in a closed online environment without the Internet, since the activity is not limited to the Internet environment, the activity can be performed at any place with enhanced mobility including movement at high speed and movement in a wide range. The term “in real time” includes a time difference caused by, for example, communication.

According to a second aspect of the disclosure, in the first aspect, the imaging section may include a plurality of imaging sections, and an image to be displayed on the head mount display may be selected by a switching function from moving images obtained by the plurality of imaging sections.

With this configuration, a wide range of image can be captured, and thus, the user can enjoy a more fulfilling activity.

A third aspect of the disclosure is directed to a method for using a third-person VR system including a non-transmissive head mount display, an imaging section, and a relay section, and the method includes: attaching the non-transmissive head mount display to a head of a user such that the non-transmissive head mount display enables the user to see an image; capturing a moving image including at least the user wearing the head mount display by the imaging section; sending, by a relay section, the moving image captured by the imaging section to the head mount display; sending, by the relay section, the moving image captured by the imaging section by a wire or wirelessly, to the head mount display in real time; and allowing the user to perform meditation while the user see an image of the user displayed on the head mount display.

With this configuration, the user can obtain further effects of meditation by performing the meditation while seeing an image of the user himself/herself by utilizing a wrapped-up sense of feeling unique to a VR technology with a non-transmissive head mount display. That is, when the user sees himself/herself from a viewpoint of others, the user can see an object from a viewpoint of others to enhance understanding of others. Thus, the effect of meditation can be greatly enhanced. In addition, when the head mount display is removed, the user realizes a difference from images seen by himself/herself before without the head mount display. Accordingly, the user can understand a difference from images usually seen by himself/herself.

According to a fourth aspect of the disclosure, in the third aspect, the user may perform meditation while gripping a specific signal generator, and the specific signal generator may include a zero-field coil, a board electrically connected to the zero-field coil, and a metal chassis covering the zero-field coil and the board and electrically connected to the board.

With this configuration, the skin of the user touches the metal chassis connected to the inner board so that information of the body is sent to a zero-field coil in the chassis through a current flow, and the information is zeroised (grounded). Accordingly, meditation can be performed more effectively.

A fifth aspect of the disclosure is directed to a third-person VR system including: a non-transmissive head mount display configured to be worn by a patient on a head of the patient and to allow the patient to see an image; an imaging section that captures a moving image including at least the patient wearing the head mount display; and a relay section that sends the moving image captured by the imaging section to the head mount display. The relay section is configured to send a moving image of the patient under a treatment captured by the imaging section to the head mount display in real time by a wire or wirelessly.

That is, during a treatment on the back of the user in, for example, an acupuncture treatment, an acupuncture and moxibustion treatment, or osteopathy, the patient lies with his/her face down, for example, and cannot see the state of the treatment. With the configuration described above, however, the patient can see the state of the treatment on the back from a viewpoint of a practitioner even while the user lies with his/her face down, for example. Accordingly, the patient can recognize which part of the body needs a treatment. This significantly enhances effects of the treatment.

According to a sixth aspect of the disclosure, the method of the first aspect may further include: preparing a room in which a plurality of obstacles, the imaging section, and the relay section are disposed; and allowing at least one user wearing the head mount display to move from a start point to a goal point in the room while seeing an image of the user displayed on the head mount display in a state where the imaging section captures an image of inside of the room.

With this configuration, in moving from the start point to the goal point, the user does not rely on a usual sense of vision while the user does not wear a head mount display but relies on an image from the imaging section so that the user can enjoy a fresh sense of feeling different from usual and can easily experience a third-person viewpoint.

According to a seventh aspect of the disclosure, the method of the first aspect may further include: preparing a room in which the imaging section and the relay section are disposed; and allowing a plurality of users each wearing the head mount display to work together in cooperation while communicating with one another and each seeing an image of himself/herself displayed on the head mount display mounted on the user, in a state where the imaging section captures an image of inside of the room.

With this configuration, participants perform the same task specified by, for example, an organizer, such as passing an object, forming a circle while holding hands with each other, or moving in a line, in cooperation by communicating with each other, while checking positions of his/her own and others in the entire room depending on an image from the imaging section. Accordingly, the participants can obtain objective viewpoints in communication.

As described above, the use of a third-person VR system enables a user to experience third-person VR easily.

### BRIEF DESCRIPTION OF THE DRAWINGS

FIG. 1 is a plan view schematically illustrating a third-person VR system according to a first embodiment of the present disclosure.

FIG. 2 schematically illustrates a communication platform.

FIG. 3 schematically illustrates a meditation method using a third-person VR system according to a second embodiment of the present disclosure.

FIG. 4 schematically illustrates a situation where a person is treated with a third-person VR system according to a third embodiment of the present disclosure.

FIG. 5 schematically illustrates a situation where an activity of forming a circle is performed using a third-person VR system according to a fourth embodiment of the present disclosure.

FIG. 6 schematically illustrates a situation where an activity in which people pass under the circle is performed using the third-person VR system of the fourth embodiment.

FIG. 7 schematically illustrates a situation where an activity of connecting people to each other in a train is performed using the third-person VR system of the fourth embodiment.

FIG. 8 schematically illustrates a situation where people are connected to each other in a train in the activity using the third-person VR system of the fourth embodiment.

### DETAILED DESCRIPTION

Embodiments of the present disclosure will be described with reference to the drawings.

### First Embodiment

—Configuration of Third-Person VR System—

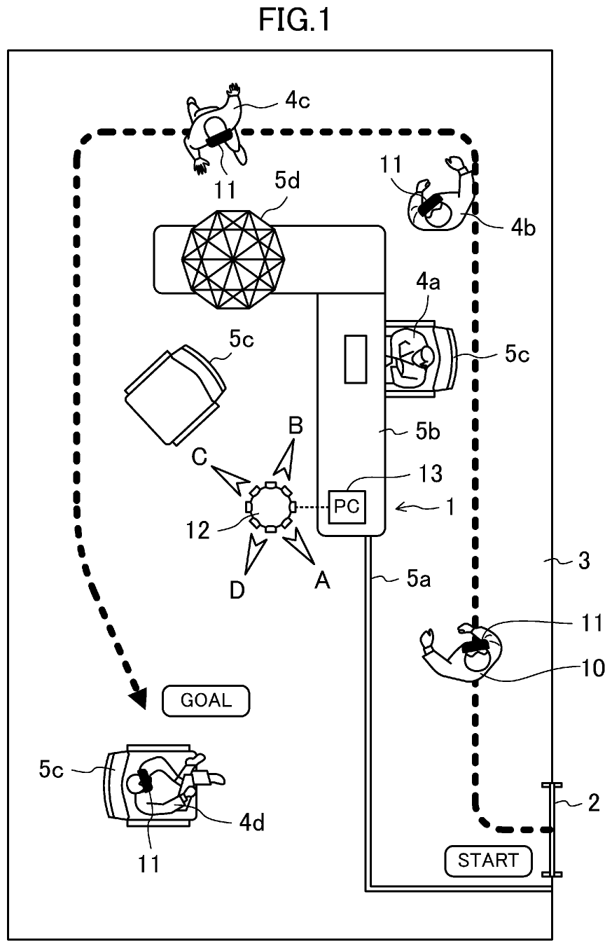

FIG. 1 is a plan view illustrating a venue where an activity using a third-person VR system 1 according to a first embodiment of the present disclosure is performed.

For example, a room 3 closed with a door 2 is prepared as a venue. The room 3 includes a user and a plurality of third persons 4a, 4b, . . . who perform an activity. In the room 3, a partition 5a, a table 5b, a chair 5c, an ornament 5d, and so forth are placed as appropriate.

The user 10 and the third persons 4a, 4b, . . . wear head mount displays 11 on their heads. Although not specifically described, preferably, each of the head mount display 11 includes at least a communication function, a display section, a battery, a goggle body, and so forth. The goggle body is preferably of a non-transmissive type (immersive type) covered with a cover and blocked from the outside. In this embodiment, it is assumed that a smartphone connectable to the Internet and including a display section is incorporated in the goggle body, for example. The smartphone is in the state of receiving live relaying through the Internet, and the goggle body includes a lens unit so as to enable the user to see the display section of the smartphone at a close distance in three dimensions.

A camera 12 serving as an imaging section is disposed in the room 3. Preferably, the camera 12 is capable of taking a moving image including at least the user 10 wearing the head mount display 11, and is a VR camera capable of taking a 360° stereoscopic moving image, for example. A single camera 12 may be disposed at a location where the camera 12 captures an image of the entire room 3, or a plurality of cameras 12 may be disposed at different locations.

The camera 12 is connected to a personal computer (PC) 13 serving as a relay section, for example. The camera 12 may be connected to the PC 13 by wires or wirelessly. The PC 13 is connected to the Internet as a relay section, and a moving image captured by the camera 12 is transmitted to an Internet live relaying.

The smartphone constituting a part of the head mount display 11 receives the Internet live relaying so that the user 10 can see the moving image (3D moving image) captured by the camera 12, in real time. The user 10 is capable of seeing the 3D image captured by the camera 12 from a preferred direction by changing the orientation of the head of the user 10 equipped with the head mount display 11.

—Method for Using Third-Person VR System—

A method for using the third-person VR system 1 according to this embodiment will now be described.

First, an operator who prepares a venue (organizer) sets a room 3 with which participants are unfamiliar. For example, the room 3 may be set like a labyrinth. The room 3 is set in such a manner that a certain number of third persons 4a, 4b, . . . are present in the room 3.

The camera 12 is started up to capture the inside of the room 3. At least one camera 12 can capture the inside of the room 3 by 360°. In some cases, as indicated by A through D in FIG. 1, the operator may change the orientation and/or position of the camera 12.

The PC 13 transmits a moving image captured by the camera 12 using the Internet to an Internet live relaying.

The user 10 wears the head mount display 11 set to receive the Internet live relaying on his/her head, and enters the room 3 through the door 2. The user 10 is concentrated on an image on the head mount display 11 and moves from a start point to a goal point while seeing an image or the like of the user himself/herself displayed on the head mount display 11. While the user 10 is moving, the user 10 does not remove the head mount display 11, and neither sees the room 3 and the user himself/herself directly with his/her eyes from, for example, below the head mount display 11 nor touches neighboring objects.

At this time, the third persons 4a, 4b, . . . perform the activity similarly.

—Advantages of Third-Person VR System—

As described above, humans are accustomed to moving themselves while feeling their own bodies based on visual information obtained with their own eyes.

In this embodiment, however, the user 10 sees his/her own body and moves not with his/her own eyes but by seeing his/her own body based on an image from the camera 12 relayed through the Internet.

When the user 10 sees himself/herself from a viewpoint of the camera 12 (third person), the body of the user 10 is seen differently from the user 10 himself/herself seen with his/her own eyes or through a mirror. In addition, by moving his/her own body based on a viewpoint of a third person, the user 10 can enjoy a fresh sense of feeling in moving his/her own body, not in moving a character on a screen.

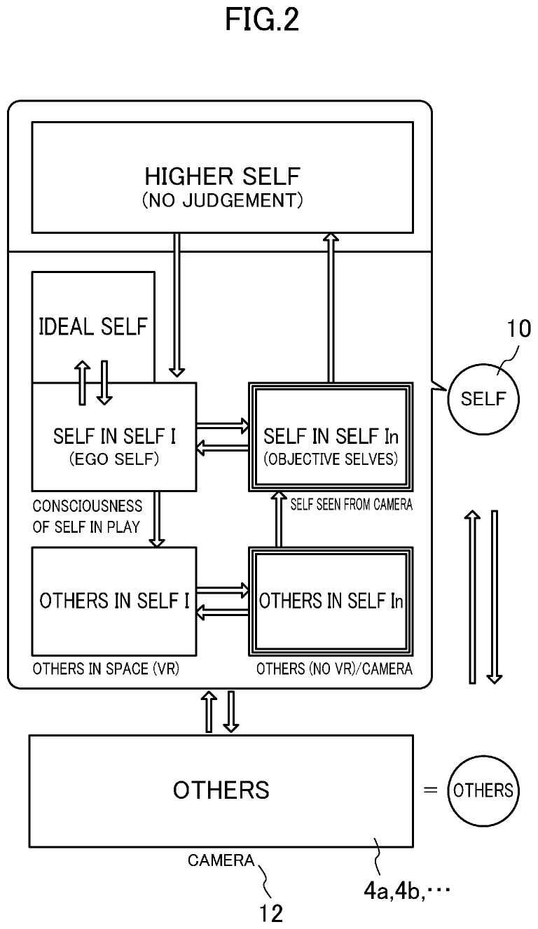

As illustrated in FIG. 2, a communication platform is a self conscious model that can be described by dividing a self-consciousness in five regions at four levels: higher self, ideal self, ego self, objective selves (plural), and others in self (plural), based on communication with others. Using this self-consciousness model, the self-consciousness state is expressed by his/her own words so that self-understanding is greatly enhanced.

When an overview of self-consciousness is recognized through a communication platform, transformation of self-consciousness begins. The change of self-consciousness leads to a change in understanding of others, resulting in spiral circulation of consciousness change. The communication platform has the function of supporting a self-consciousness to be transformed, in other words, progress of self-consciousness.

In view of this, in this embodiment, a captured image is seen in a first stage. This is an action of seeing an object except for the user himself/herself from a viewpoint of a third person.

In a second stage, a moving image including the user himself/herself is seen from a third-person viewpoint with the third-person VR system 1 as described in this embodiment.

In a third stage, the user recognizes the user himself/herself from a third-person viewpoint with the third-person VR system 1.

In a fourth stage, the user sees the user himself/herself in a plurality of third persons, from a third-person viewpoint.

In a fifth stage, a difference between an image seen with the user's own eyes while the head mount display 11 is removed and an image seen with the third-person VR system 1 is recognized so that the user comes to be capable of recognizing himself/herself from a third-person viewpoint even with the head mount display 11 removed. Accordingly, self-consciousness can be progressed.

In this embodiment, even if a large number of head mount displays 11 are used, the user of the Internet is less likely to degrade a communication state, than the case of using a wireless LAN. Furthermore, the user can enjoy a sense of feeling different from usual in performing an activity because of a slight time difference over the Internet relaying.

A plurality of cameras 12 may be provided such that a moving image to be displayed on the head mount display 11 is selected by a switching function from moving images captured by the plurality of cameras 12. In this case, a wide range of image can be captured, and thus, the user can enjoy a more fulfilling activity.

Thus, the third-person VR system 1 according to this embodiment enables the user to experience third-person VR easily and to enjoy a fresh sense of feeling different from usual.

### Second Embodiment

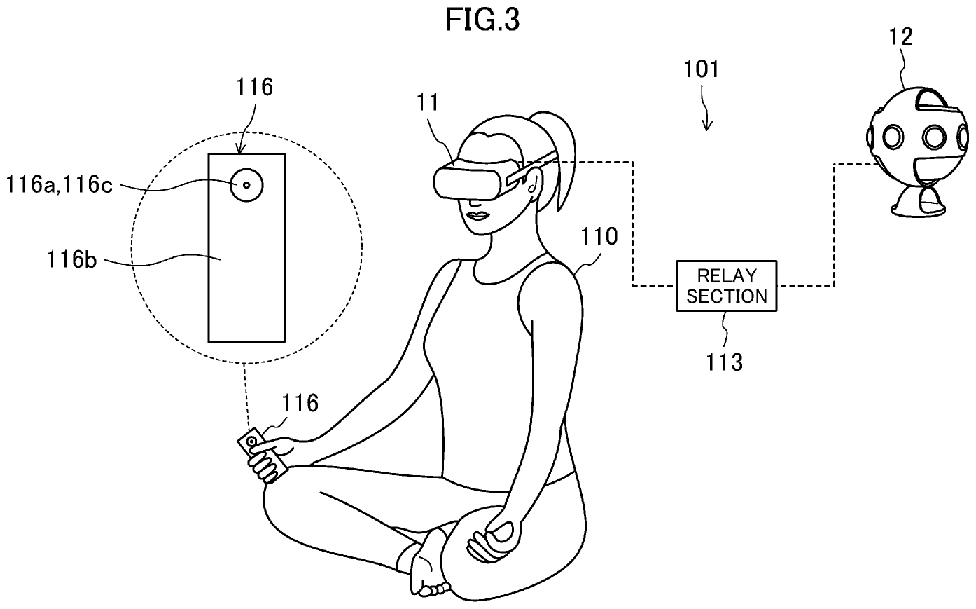

FIG. 3 illustrates a third-person VR system 101 according to a second embodiment of the present disclosure. The third-person VR system 101 is different from the third-person VR system 101 of the first embodiment in using the third-person VR system 101 while a user 110 is stationary in, for example, Zen meditation. In the following embodiments, components already described with reference to FIGS. 1 and 2 are denoted by the same reference characters, and will not be described again in detail.

In a method for using the third-person VR system 101 according to this embodiment, the user 110 uses a head mount display 11 in meditation.

A camera 12 is disposed in a room where meditation is to be performed. In an existing method, a user performs meditation while seeing his/her own appearance objectively with a mirror in front of the user. If the mirror is located at the rear (at the back) of the user, the user can perform meditation while seeing the user himself/herself from the back, which is not usually seen. A plurality of cameras 12 may be provided so that a plurality of moving images are switched to one another. The user may perform meditation alone or with others in the same room at the same time.

A relay section 113 sends a moving image captured by the camera 12 to a head mount display 11 in real time by wires or wirelessly. In this case, a moving image from the camera 12 may be transmitted to the head mount display 11 in real time by a relay section 113 without interposition of Internet live relaying, unlike the first embodiment. As a wireless technique, a known wireless LAN may be used so that an image can be seen without a time difference.

In such a state, the user 110 performs meditation while seeing the user 110 himself/herself displayed on the head mount display 11. Accordingly, during meditation, the user 110 can not only check the posture of himself/herself but also obtain further effects of the meditation while seeing an image of himself/herself by utilizing a wrapped-up sense of feeling unique to a VR technique using a non-transmissive head mount display 11. That is, when the user sees himself/herself from a viewpoint of others, the user can see an object from a viewpoint of others to enhance understanding of others. Thus, effects of meditation can be greatly enhanced. In addition, when the head mount display 11 is removed, the user realizes a difference from images seen by the user before. Accordingly, the user can understand a difference from images usually seen by the user.

For example, the effects are further enhanced when the user uses the third-person VR system 101 while gripping a specific signal generator 116 that emits signals including specific low frequencies of compressional waves based on language frequencies at high speed. For example, basic frequencies of the “specific low frequencies” are composed of, for example, compressional waves at 6 to 50 Hz. The specific signal generator 116 emits signals in a frequency range of 35 kHz in average at a high speed of about 1400 times. This speed is not limited to a specific speed of 1400 times, but as the emission speed increases, the amount of issued information increases advantageously. The user may perform meditation while listening to music in which such specific low frequencies are superimposed on one another. By gripping the specific signal generator 116 of a hand-gripped type as illustrated in FIG. 3, the skin of the user touches a metal chassis 116b of, for example, titanium connected to an inner board 116a so that information of the body is sent to a zero-field coil 116c in the metal chassis 116b through a current flow. Consequently, information is zeroised (grounded). In this manner, meditation can be more effectively performed. The specific signal generator 116 may be used while being connected to a plug-in ground as an electromagnetic wave remover. In this case, grounding is more efficiently performed.

As described above, in the third-person VR system 101 according to the second embodiment, the user can also experience third-person VR easily, and can perform much more effectively.

### Third Embodiment

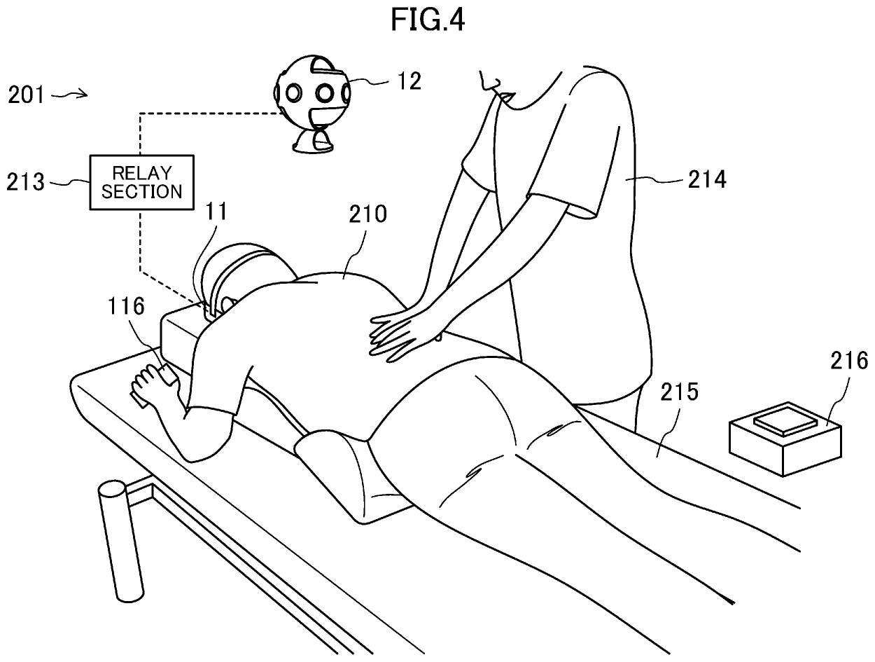

FIG. 4 illustrates a third-person VR system 201 according to a third embodiment of the present disclosure. The third-person VR system 201 of the third embodiment is different from that of the second embodiment mainly in purposes of application.

In the third embodiment, a person (patient) 210 under a treatment on the back, such as an acupuncture treatment, an acupuncture and moxibustion treatment, or osteopathy, lies on a treatment bed 215 while wearing a head mount display 11. For example, if the treatment bed 215 has a relatively large unillustrated opening in a head portion thereof, the patient can easily lie with his/her face down without disturbance of the head mount display 11. The patient 210 may be in a sitting position or a standing position during the treatment.

A camera 12 is placed on, for example, a wall near the treatment bed 215. The camera 12 captures a moving image including the patient 210 wearing the head mount display 11.

The moving image captured by the camera 12 is relayed by a relay section 213, and is transmitted to the head mount display 11 in real time. The relay section 213 may be included in the camera 12 or in the head mount display 11 itself. The relaying method may be wireless or, because of small movement, may be performed through wires. As a wireless technique, a known wireless LAN may be used so that an image can be seen without a time difference.

In this embodiment, the patient may also receive a treatment while gripping a specific signal generator 116 as in the second embodiment, or may receive a treatment in a state where a specific signal generator 216 for generating signals including specific low frequencies at high speed is placed near the treatment bed 215 and is caused to generate signals including specific low frequencies. In this case, the patient can be kept calm during the treatment so that effects of the treatment can be enhanced. A practitioner 214 can also be kept calm and concentrated on the treatment.

As described above, during a treatment on the back in, for example, an acupuncture treatment or an acupuncture and moxibustion treatment, the patient 210 lies with his/her face down, for example, and cannot see the state of the treatment.

In this embodiment, however, the patient 210 can see the state of the treatment on his/her own back with, for example, his/her face down, from a viewpoint of the practitioner 214.

Accordingly, the patient 210 can recognize which part of the body is treated and how the treatment is being performed. This significantly enhances effects of the treatment.

If the patient 210 has a skill for a treatment such as an acupuncture treatment or osteopathy, the patient 210 can imagine a treatment with an image of performing a treatment by himself/herself on a portion of the body suffering from a problem while looking at the back to which the patient 210 cannot reach, in a posture as in the second embodiment. In this manner, advantages as if the patient 210 had received an actual treatment can be obtained.

Thus, in the third-person VR system 201 of the third embodiment, the user can also experience third-person VR, and can receive a treatment effectively.

### Fourth Embodiment

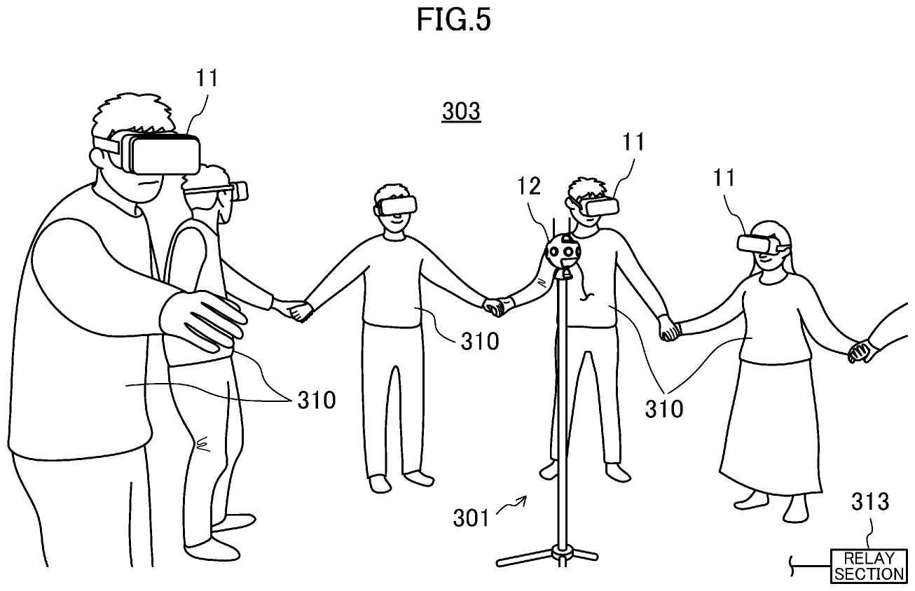

FIGS. 5 through 8 illustrate a state of performing an activity using a third-person VR system 301 according to a fourth embodiment of the present disclosure. In a manner similar to the first embodiment, the third-person VR system 301 also employs a 360° viewpoint relay camera (camera 12) placed in a room 303, and the camera 12 is connected to a relay section 313. The relay section 313 may have the same configuration as that of the first embodiment, or may use the Internet or a LAN.

The fourth embodiment is different from the above embodiments in that a plurality of users wearing non-transmissive head mount displays 11 perform one activity in cooperation.

Specifically, each of the users 310 wearing the head mount displays 11 sees, through the head mount display 11, an image obtained by the 360° viewpoint relay camera (camera 12) placed in the room 303 in which the users 310 are present. The viewpoint shared by the users 310 can be, for example, a viewpoint of a team leader when the users 310 work together as a team. For example, in the case of a firm, the shared viewpoint is a viewpoint of a president, and in the case of a sport, the shared viewpoint is a viewpoint of a supervisor. From the shared viewpoint, the users 310 perform an activity for the same purpose and work together as a team.

A specific activity is specified by an organizer or the like each time. For example, as illustrated in FIG. 5, all the users try to form a circle by connecting their hands with each other based on an image displayed on the head mount displays 11. Since the users 310 wear the immersive-type head mount displays 11, the user 310 seeks the position of himself/herself and the positions of others not based on his/her own viewpoints but based on the viewpoint of the camera 12.

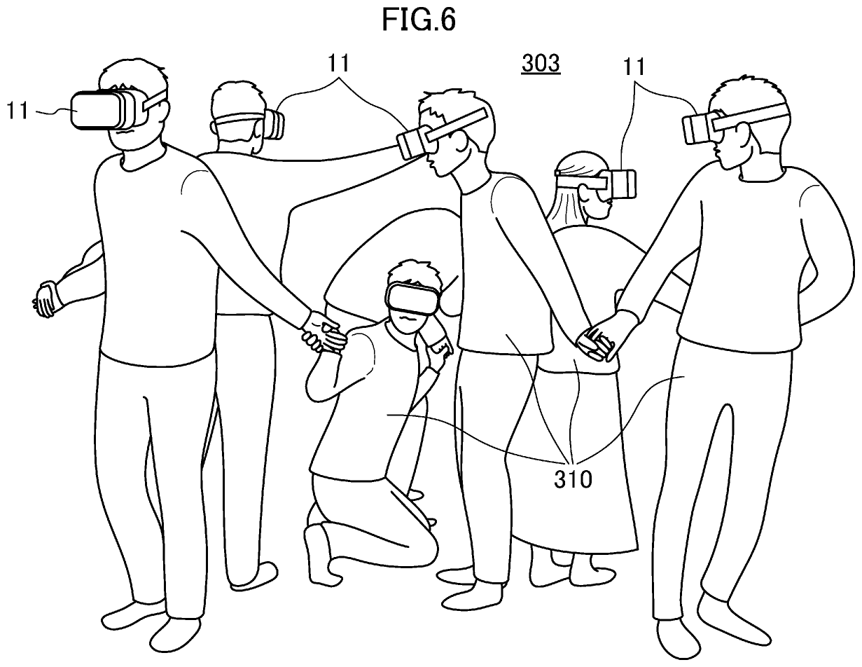

As another activity, as illustrated in FIG. 6, the users form a circle with their backs to each other, and then, in the same state, users pass between specified two of the users. This activity needs to be performed by checking the positions of themselves and the positions of others from the viewpoint of the camera 12 at an unillustrated position, and the user cannot perform the activity without moving in communication with others.

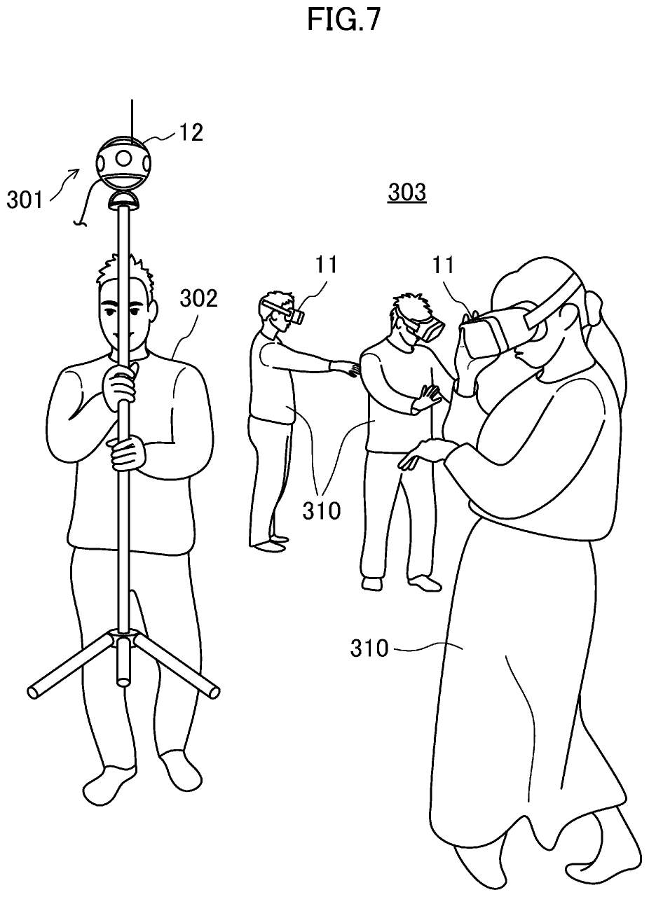

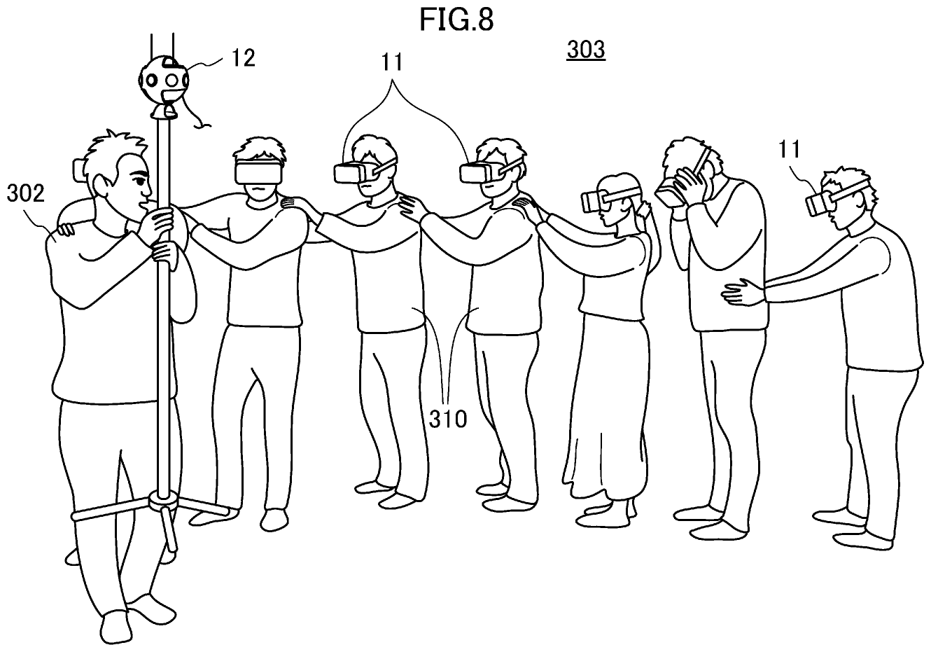

In addition, as illustrated in FIG. 7, as yet another activity, the users try to connect to each other in a train while seeing an image from a moving relay camera in a bird's-eye view. An activity organizer 302 holding the camera 12 moves with the camera 12. As illustrated in FIG. 8, all the participants in the activity are aimed to be connected to the activity organizer 302 finally. First, it takes time for users to recognize positions of themselves with respect to the camera 12 and positions of themselves with respect to others.

As described above, since each user 310 wears the non-transmissive (immersive-type) head mount display 11, the user 310 cannot confirm the position of himself/herself or the like from his/her own viewpoint, and needs to perform an activity based on a common 3D image displayed from the camera 12. Since the users 310 take actions mainly based on the sense of vision in a dairy life, the users 310 need to perform one activity in cooperation while communicating with each other. The users cannot perform any activity without objectively seeing the positions of themselves and positions of others in the entire room 303 depending on an image from the camera 12. In the presence of a time lag, a necessity for communication significantly increases. Communication creates a phenomenon in which the users get to relate to each other by heart.

In this embodiment, a “third-person viewpoint” shared by a user and others is set, and the users attain one goal as a group while sharing a third-person viewpoint. The figure as a group is exactly a family or a team in a job.

The activity creates an objective vision to an existence of “ego” or “me.” That is, the objective vision is an objective viewpoint of a “third-person viewpoint.” In addition, since the users perform an activity from the common viewpoint, each user has confidence of “sharing a common viewpoint” between the user and others or in the group. Accordingly, an important objective viewpoint in communication can be obtained.

If such an activity is performed as a cooperate training, a communication skill away from a viewpoint of a user himself/herself in a group can be obtained in a short time. Furthermore, in the course of working with others, a training for eliminating the belief that the user himself/herself is right can be performed.

The present disclosure is also applicable to the following example. In this example, the camera 12 is replaced by a camera of a head mount display worn by each user. This easily creates a “situation where a user has to act only based on a viewpoint of a third person (third-person viewpoint).”

Specifically, a method for using a third-person VR system includes: preparing a non-transmissive first head mount display including a first camera capable of capturing a first VR moving image and a first communication section for sending the first VR moving image and configured to enable a first user wearing the first head mount display on a head of the first user to see a received image, and a non-transmissive second head mount display including a second camera capable of capturing a second VR moving image and a second communication section for sending the second VR moving image and configured to enable a second user wearing the second head mount display on a head of the second user to see a received image; and allowing the first user wearing the first head mount display and the second user wearing the second head mount display to work together in cooperation while communicating with each other in a state where the second VR moving image is displayed on the first head mount display through a relay section and the first VR moving image is displayed on the second head mount display through the relay section.

The term “work together” here refers to an activity that is instructed by, for example, an organizer and is simple when performed by a user based on his/her own viewpoint but has to be performed in a “situation where the user has to act only based on a viewpoint of a third person,” such as an activity in which users shake their hands or an activity in which one user takes a PET bottle on the ground based on an instruction of the other user.

In the method for using the third-person VR system, the activity described above is performed by attaching a first mobile terminal including the first camera and capable of communicating with the relay section to the first head mount display, attaching a second mobile terminal including the second camera and capable of communicating with the relay section to the second head mount display, and either allowing the first user to capture a VR moving image of the second user with the first camera based on an instruction by the second user, or allowing the second user to take a VR moving image of the first user with the second camera based on an instruction by the first user.

In this case, the mobile terminals are, for example, transmissible smartphones, and the users are allowed to use a video call application installed in the smartphones. Specifically, first, two smartphones are prepared, set in a state where a video call is made between these smartphones, and each switched to a rear camera mode (to a mode not capturing an image of the user himself/herself) of the smartphone and to a mute mode for preventing howling. Then, the smartphones are mounted on the head mount displays. Each of a pair of the users wearing the head mount displays confirms that he/she sees himself/herself from the viewpoint of the smartphone of the other in the pair. Thereafter, the users work together in accordance with an instruction of, for example, an organizer.

In such a situation of the activity, it turns out that the users work as a poor-communication pair or, in contrast, a well-cooperated pair. If a pair usually working together in a job performs such an activity, it is possible to optimize a human relationship in the job, for example, to find a communication error occurring in the job.

This method can be performed by using a program for controlling a third-person VR system including: a non-transmissive first head mount display including a first camera capable of capturing a first VR moving image, a first communication section for sending the first VR moving image, and a first computer for performing control such that a first user wearing the first head mount display on a head of the first user sees a received image; a non-transmissive second head mount display including a second camera capable of capturing a second VR moving image, a second communication section for sending the second VR moving image, and a second computer for performing control such that a second user wearing the second head mount display on a head of the second user sees a received image; and a relay section enabling the first head mount display and the second head mount display to communicate with each other.

This program causes the first computer to capture the first VR moving image with the first camera, send the first VR moving image to the relay section, receive the second VR moving image through the relay section, and make the second VR moving image displayed on the first head mount display in real time, and causes the second computer to capture the second VR moving image with the second camera, send the second VR moving image to the relay section, receive the first VR moving image through the relay section, and make the first VR moving image displayed on the second head mount display in real time.

In this case, first, two smartphones are prepared, and connected to each other with a viewpoint exchange application including the program launched. These smartphones are mounted on the head mount displays. Each of a pair of the users wearing the head mount displays confirms that he/she sees an image from the viewpoint of the smartphone of the other in the pair. Then, the users work together based on an instruction of, for example, an organizer.

This application enables a viewpoint exchange in not only a one-to-one relationship but also among a plurality of users. For example, in the case of five users, it is possible to provide an activity in which a state where each of the users has a viewpoint of another is created, and each of the users guesses from whose viewpoint he/she sees. If the viewpoint is switched at random with one button, the users can recognize a larger number of viewpoints of others.

As described above, it is possible to create a situation where each user can easily switch a viewpoint of his/her own to a viewpoint of another and has to act only based on a viewpoint of a third person only by launching a dedicated viewpoint exchange VR application on his/her smartphone and setting the smartphone on his/her head mount display. In this situation, a “state where only a viewpoint is exchanged” is created with five senses except for visibility kept normal, resulting in disturbance of consciousness. A process in which a user finds a viewpoint of a third person in this disturbed state of consciousness, accepts this viewpoint, and acts based on the viewpoint of a third parson, effectively works to acquire a “viewpoint of a third person (i.e., third-person viewpoint).

In this activity, a user acquires an experience in which the user cannot change a viewpoint of a third person by the user himself/herself, and has no other choice but to follow the viewpoint of the third person. In other words, the user is forced to be in a “situation where the user has to fully respect a third person.” This leads to an understanding of a third person, and the user acquires a viewpoint of a third person the user yet to have acquired. In addition, unless the user does not communicate verbally, the user does not know whose viewpoint is displayed on his/her head mount display. Thus, it is inevitable for the user to communicate with a third person.

### OTHER EMBODIMENTS

Embodiments of the present disclosure may have the following configuration.

Although the embodiments have been directed to the case where the smartphone is mounted on the head mount display 11, the head mount display 11 itself includes a communication function, or the relay sections 13, 113, 213, and 313 may be provided in the camera 12 or in the head mount display 11.

In the first embodiment, relaying is performed by using the Internet. Alternatively, a wireless LAN as described in the second and third embodiments may be used, or wired communication may be used in some cases. The relay section herein includes a communication device such as a PC, a router, a server, and an Internet connection in the case of using the Internet, and includes a communication device such as a PC, a router, a server, and a LAN connection in the case of using a LAN. In the first and fourth embodiments, an activity may be performed in a state in which the specific signal generator 216 is placed in the room 3 and generates signals including specific low frequencies, or in a state where the user 10 grips the specific signal generator 116 by hands or hooks the specific signal generator 116 on his/her neck. Accordingly, it is possible not only to enjoy an activity but also to expect further transformation (including obtaining an objective viewpoint and a bird's-eye viewpoint) of self-consciousness.

The third-person VR systems according to the first through fourth embodiments are applicable to other activities, sports, plays, and so forth. That is, a motion in these activities can be effectively enhanced by recognizing motion of the body himself/herself from a viewpoint of others.

The foregoing embodiments are merely preferred examples in nature, and are not intended to limit the disclosure, applications, and use of the application.

What is claimed is:

1. A method for using a third-person VR system including a non-transmissive head mount display, an imaging section, and a relay section, the method comprising:
attaching the non-transmissive head mount display to a head of a user such that the non-transmissive head mount display enables the user to see an image;
capturing a moving image including at least the user wearing the head mount display by the imaging section;
sending, by the relay section, the moving image captured by the imaging section to the head mount display;
sending, by the relay section, the image captured by the imaging section by using a communication line such as Internet, to the head mount display in real time; and
allowing the user to perform an activity while the user see an image of the user displayed on the head mount display.

2. The method for using the third-person VR system according to claim 1, wherein
the imaging section comprises a plurality of imaging sections, and
an image to be displayed on the head mount display is selected by a switching function from moving images obtained by the plurality of imaging sections.

3. A method for using a third-person VR system including a non-transmissive head mount display, an imaging section, and a relay section, the method comprising:
attaching the non-transmissive head mount display to a head of a user such that the non-transmissive head mount display enables the user to see an image;
capturing a moving image including at least the user wearing the head mount display by the imaging section;
sending, by the relay section, the moving image captured by the imaging section to the head mount display;
sending, by the relay section, the moving image captured by the imaging section by a wire or wirelessly, to the head mount display in real time; and
allowing the user to perform meditation while the user sees an image of the user displayed on the head mount display.

4. The method for using the third-person VR system according to claim 3, wherein
the user performs meditation while gripping a specific signal generator, and
the specific signal generator includes a zero-field coil, a board electrically connected to the zero-field coil, and a metal chassis covering the zero-field coil and the board and electrically connected to the board.

5. A third-person VR system comprising:
a non-transmissive head mount display configured to be worn by a patient on a head of the patient and to allow the patient to see an image;
an imaging section that captures a moving image including at least the patient wearing the head mount display; and
a relay section that sends the moving image captured by the imaging section to the head mount display, wherein
the relay section is configured to send a moving image of the patient under a treatment captured by the imaging section, to the head mount display in real time by a wire or wirelessly.

6. The method for using the third-person VR system according to claim 1, further comprising:
preparing a room in which a plurality of obstacles, the imaging section, and the relay section are disposed; and
allowing at least one user wearing the head mount display to move from a start point to a goal point in the room while seeing an image of the user displayed on the head mount display in a state where the imaging section captures an image of inside of the room.

7. The method for using the third-person VR system according to claim 1, further comprising:
preparing a room in which the imaging section and the relay section are disposed, and
allowing a plurality of users each wearing the head mount display to work together in cooperation while communicating with one another and each seeing an image of himself/herself displayed on the head mount display mounted on the user, in a state where the imaging section captures an image of inside of the room.
